(19) United States
(12) Patent Application Publication
(10) Pub. No.: US 2014/0340324 A1
(43) Pub. Date: Nov. 20, 2014

(54) HANDHELD ELECTRONIC DEVICES

(71) Applicant: EMPIRE TECHNOLOGY DEVELOPMENT LLC, Wilmington (DE)

(72) Inventor: Zhen Xiao, Beijing (CN)

(21) Appl. No.: 14/126,382

(22) PCT Filed: Nov. 27, 2012
(86) PCT No.: PCT/CN2012/085342

§ 371 Date: Dec. 13, 2013

(51) Int. Cl. G06F 3/041; G06F 3/01

(52) U.S. Cl. CPC G06F 3/041; G06F 3/017; G06F 2203/04104
USPC 345/173

(57) ABSTRACT

Technologies are generally described for handheld electronic devices. In various examples, a handheld electronic device arranged in accordance with the present technology can include a display on a first side and a user input device having a sensor on a second side opposite the first side. The sensor can be configured to detect finger locations of a user on the second side relative to the user input device and to generate a sense signal accordingly. An indication may be presented on the display at the first side based on the sense signal.

### BACKGROUND

Handheld electronic devices (e.g., tablet computers and smart phones) typically have a display for outputting and a keyboard for inputting data to/from a user. In certain handheld electronic devices, the display may be touch sensitive, and a “virtual” keyboard may be presented to the user on the display. In other handheld electronic devices, a physical keyboard (e.g., a QWERTY keyboard) may be positioned adjacent the display. However, in many of these handheld electronic devices, the physical and/or “virtual” keyboard may occupy a portion of the surface area on or adjacent the display, and thus may reduce possible display area. In addition, conventional physical and/or “virtual” keyboards are typically configured for operation with left and/or right thumbs, and thus do not use all ten fingers. Therefore, such conventional keyboards may have limited speed of data entry.

Unless otherwise indicated herein, the materials described in this section are not prior art to the claims in this application and are not admitted to be prior art by inclusion in this section.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a schematic diagram illustrating a front view of a handheld electronic device in accordance with the present disclosure;

FIG. 2 is a schematic diagram illustrating a back view the handheld electronic device in FIG. 1;

FIG. 3A is a schematic cross-sectional diagram illustrating an input element suitable for the first input device shown in FIGS. 1 and 2;

FIG. 3B is a schematic cross-sectional diagram illustrating another input element suitable for the first input device shown in FIGS. 1 and 2;

FIG. 3C is a schematic plan view diagram illustrating another example first input device suitable for the handheld electronic device shown in FIGS. 1 and 2;

FIG. 3D is a schematic plan view diagram illustrating a further example first input device suitable for the handheld electronic device shown in FIGS. 1 and 2;

FIG. 3E is a schematic cross-sectional diagram of the first input device shown in FIG. 3D;

FIG. 4 is a schematic diagram illustrating an example circuit suitable for the handheld electronic device shown in FIGS. 1 and 2;

FIG. 5 is a flow diagram illustrating a process for operating the handheld electronic device shown in FIGS. 1 and 2;

FIGS. 6-13 are schematic diagrams illustrating example screens for operating the handheld electronic device;

FIG. 14 is a schematic diagram illustrating a front view of another example handheld electronic device in accordance with the present disclosure;

FIG. 15 is a schematic diagram illustrating a back view the handheld electronic device in FIG. 14;

FIG. 16 is a flow diagram illustrating a process for operating the handheld electronic device shown in FIGS. 14 and 15;

FIGS. 17-20 are schematic diagrams illustrating example screens for operating the handheld electronic device;

FIG. 21 is a schematic circuit diagram illustrating an example first input device suitable for the handheld electronic device shown in FIGS. 1, 2, 14, and 15;

FIG. 22 is a schematic diagram illustrating an example computing device that is arranged for the handheld electronic devices in accordance with the present disclosure; and

FIG. 23 is a schematic diagram illustrating an example computer program product that includes a computer program for executing a computer process on a computing device to perform an Input Device Virtual Mapping Process; all arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to input mechanisms for handheld electronic devices.

Briefly stated, a handheld electronic device arranged in accordance with embodiments of the present technology can include a display on a first side and a user input device having a sensor on a second side opposite the first side. The sensor is configured to detect finger locations of a user on the second side relative to the user input device and to generate a sense signal accordingly. An indication may be presented on the display at the first side based on the sense signal.

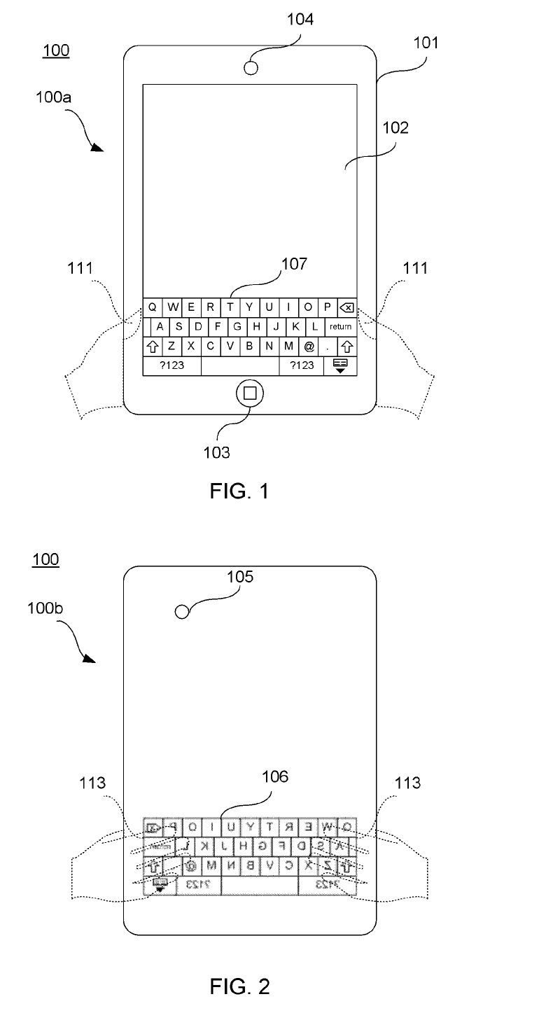

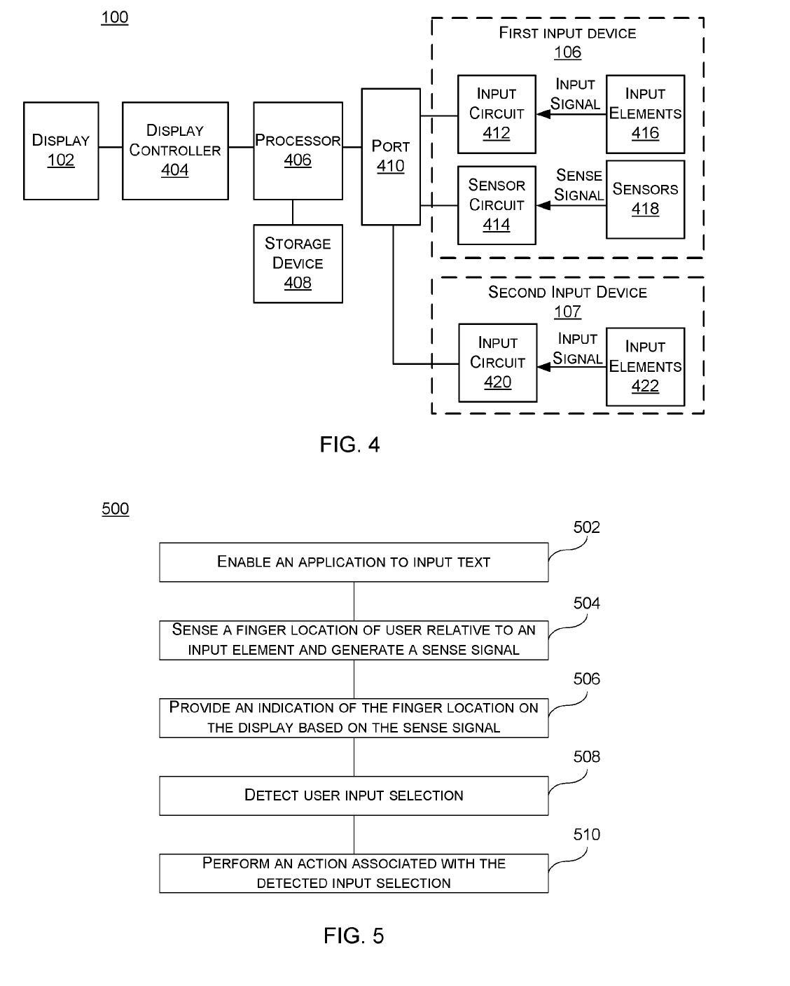

FIG. 1 is a schematic diagram illustrating a front view and FIG. 2 is a schematic diagram illustrating a back view of a handheld electronic device 100, arranged in accordance with at least some embodiments of the present disclosure. The handheld electronic device 100 can be a tablet computer, a smart phone, a person digital assistant (PDA), and/or other suitable handheld electronic devices. Referring to both FIGS. 1 and 2, the handheld electronic device 100 can include a housing 101 having a first side 100a opposite a second side 100b. In some examples, the first and second sides 100a, 100b correspond to front and back sides of the handheld electronic device, respectively. The handheld electronic device 100 can also include a display 102 on the first side 100a and a first input device 106 on the second side 100b of the housing 101. The handheld electronic device 100 can also include one or more of a processor, a display controller, a storage device, and/or other electrical components internally located in the housing 101, as described in more detailed below with reference to FIG. 4.

In the illustrated embodiment, the handheld electronic device 100 may also include one or more of a home button 103 and a front-facing camera 104 on the first side 100a of the housing 101, and/or a rear-facing camera 105 on the second side 100b of the housing 101. In other embodiments, the handheld electronic device 100 can also include one or more of a speaker, a microphone, a jog wheel, a volume control, and/or other suitable electronic and/or mechanical components on the first side 100a, the second side 100b, or other suitable locations of the housing 101.

The display 102 can include a liquid crystal display, a light emitting diode display, an electroluminescent display, a plasma display, an organic light-emitting diode display, and/or other suitable components configured to output images, videos, and/or text to a user. In certain embodiments, the display 102 may be touch sensitive. For example, the display 102 may include a resistive, a surface-acoustic-wave, a capacitive, a surface capacitance, a projected capacitance, a mutual capacitance, a self-capacitance, an infrared, an optical imaging, an acoustic pulse recognition, or a force-sensing touchscreen. In further embodiments, the display 102 may include carbon nanotube, quantum dot, and/or other suitable types of output components.

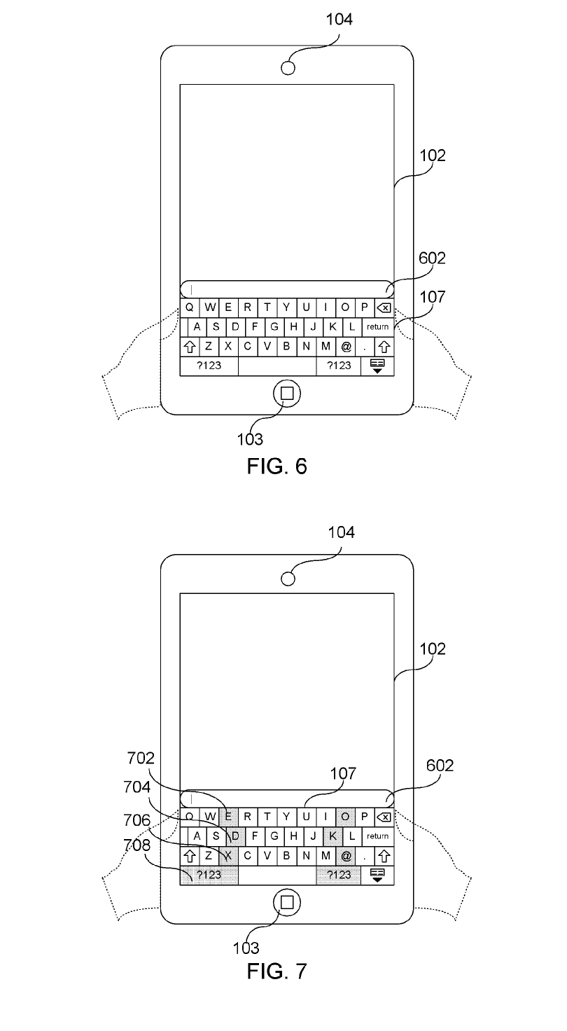

In various embodiments, the handheld electronic device 100 may have a second input device 107 at the first side 100a. The second input device 107 can have a plurality of input elements such as keys, buttons, switches, user-defined key positions or other suitable input elements configured to be actuated by a user. In the illustrated embodiment, the handheld electronic device 100 may present a “virtual” input device on the display 102. The “virtual” input device may be a software input device generally corresponding to the first input device 106, or different from the first input device 106. Indications of finger locations on the second side 100b of the housing 101 can be displayed on the virtual input device or other locations on the display 102, as described in more detail below with reference to FIGS. 6-13. In other embodiments, the “virtual” input device can be any suitable virtual keypad, virtual keyboard or some other variety of virtual input devices such as a virtual joypad, a virtual mouse, a virtual pointer, or other suitable virtual input device.

In still other embodiments, the second input device 107 can be any suitable keypad, keyboard or some other variety of input devices such as a joypad, a mouse, a pointer, or other suitable input device. In some embodiments, the second input device 107 can be any suitable keyboard, such as a mechanical keyboard (e.g., having multiple key switches), a foldable keyboard, an optical keyboard, and/or other suitable types of keyboard. In various examples, the second input device 107 may be a mechanical keypad (e.g., having multiple key switches), a foldable keypad, an optical keypad, and/or other suitable types of keypad. In other embodiments, the second input device 107 may be joysticks/joypads, mouse/touch pad pointers, scroll wheels, or any suitable user input device,

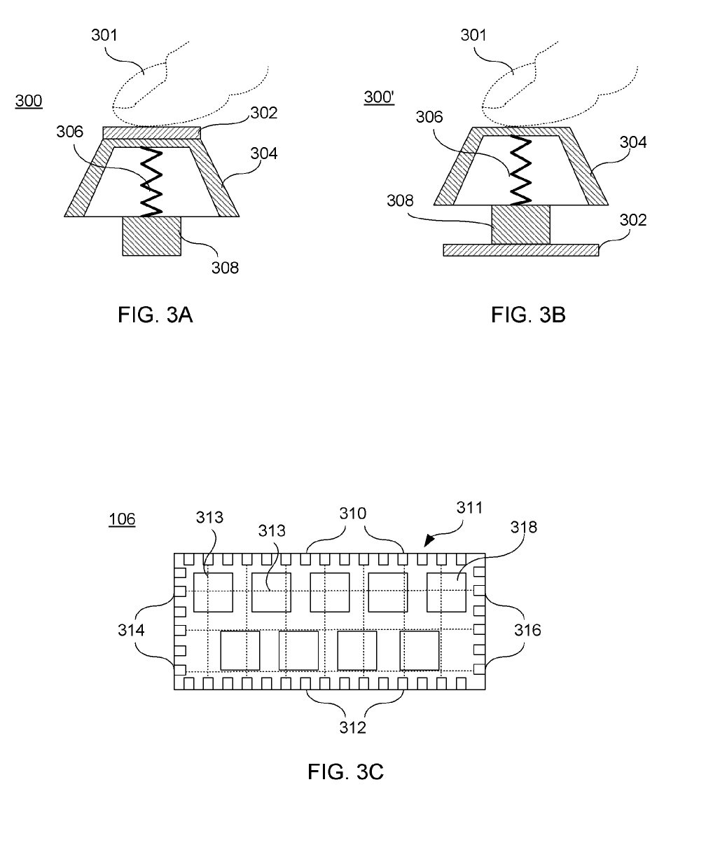

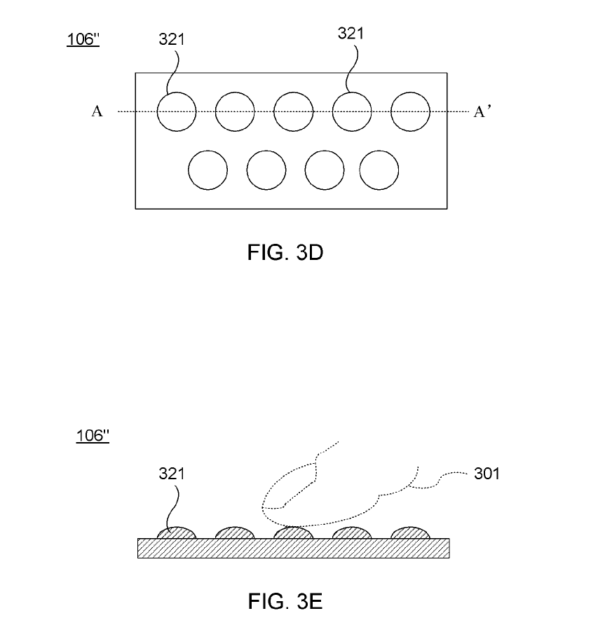

The first input device 106 can have a plurality of input elements such as keys, buttons, switches, or other suitable input elements configured to be actuated by a user. In some embodiments, the first input device 106 can be any suitable keyboard, such as a mechanical keyboard (e.g., having multiple key switches), a foldable keyboard, an optical keyboard, and/or other suitable types of keyboard. The layout of the keyboard may be either be implemented as a virtual keyboard (i.e., virtually defined key positions) or a physical keyboard (i.e., with predefined physical key positions) arranged according to any desired key arrangement. For example, in one embodiment, the keyboard can be arranged as a QWERTY keyboard. In other embodiments, the keyboard can have a QWERTZ, AZERTY, QZERTY, and/or other suitable types of layout. Several example input elements and first input device are described below in more detail with reference to FIGS. 3A-3C.

In other embodiments, the first input device 106 can be any suitable keypad (or partial keypad) or some other variety of input device such as a game controller, mouse, pointer, touchpad or other suitable device. In various examples, the first input device 106 may be a mechanical keypad (e.g., having multiple key switches), a foldable keypad, an optical keypad, and/or other suitable types of keypad. In various other examples, the first input device 106 may be a joypad type of device, such as mechanical joypad (e.g., having multiple key switches), a foldable joypad, an optical joypad, and/or other suitable types of joypad. In some alternatives, the first input device 106 may be implemented as a touch panel that has a plurality of virtual keys defined by a user (e.g., specific keys associated with a keypad, keyboard, mouse, pointer, joypad, etc., which may defined relative or adjacent one another by a user's approximate finger positions according to a user defined profile). Various other gaming, keyboard, keypad, touchpad based input devices are also contemplated.

In operation, a user may use the first input device 106 and/or the second input device 107 to input data to the handheld electronic device 100 at faster rates than conventional devices. For example, the user can hold the handheld electronic device 100 by placing left and right thumbs 111 on the first side 100a and the remaining fingers 113 on the second side 100b of the housing 101. The left and right thumbs 111 and the other fingers 113 are shown in phantom lines for clarity. In certain embodiments, the user can use both left and right thumbs 111 to input data using the second input device 107 on the first side 100a and simultaneously use the other fingers 113 to input data using the first input device 106 on the second side 100b, resulting in faster rates of data entry. In other embodiments, the user may use the second input device 107 and/or the first input device 106 for entering data.

In certain embodiments, the handheld electronic device 100 can be configured to provide the user with visual feedback of the locations of the fingers 113 during data entry. For example, the first input device 106 can be configured to detect finger locations of the fingers 113 relative to one of the input elements on the first input device 106. The detected finger locations can then be indicated on the display for user feedback. For example, the detected finger locations may be indicated by highlighting the virtual key corresponding to the finger location, or by providing an indication on the display in other suitable manners. Several examples of detecting and displaying finger locations relative to at least one input element of the first input device 106 are described in more detail below with reference to FIGS. 6-13. In other embodiments, the handheld electronic device 100 can be configured to provide voice, tactile, and/or other types of finger location feedback to the user in addition to or in lieu of the visual feedback.

FIG. 3A is a schematic cross-sectional diagram illustrating an input element 300 suitable for use in a first input device such as first input device 106 shown in FIGS. 1 and 2, arranged in accordance with at least some embodiments of the present disclosure. Though only one input element 300 is illustrated in FIG. 3A, the first input device 106 may include a plurality of input element generally similar to input element 300, or different from input element 300. As shown in FIG. 3A, the input element 300 can include a finger piece 304, a tactile sensing element 302 on the finger piece 304, and a shaft 308 supporting the finger piece 304 with a spring 306. The input element 300 can also include one or more electrical contacts (not shown) and/or circuits configured to output keystrokes. The tactile sensing element 302 can include one or more resistive, capacitive, and/or other suitable types of sensors configured to detect a contact with a finger 113 (FIG. 2) and generate a sense signal indicative of the detected finger contact.

In operation, the handheld electronic device 100 (FIGS. 1 and 2) is adapted to detect a finger location of the user by monitoring the tactile sensing element 302. For example, as shown in FIG. 3A, when the user's finger 301 touches the tactile sensing element 302, the tactile sensing element 302 generates a sense signal and provides the generated sense signal to the handheld electronic device 100 (FIGS. 1 and 2) for display on the “virtual” keyboard in FIGS. 1 and 2. If the user determines that the indicated finger location is for a desired input element, the user may activate the input element 300 to register an actuation by pressing the finger piece 304 toward the shaft 308. As a result, the spring 306 is depressed to activate the one or more electrical contacts of the input element 300, and thus registering actuation.

Even though the tactile sensing element 302 is shown in FIG. 3A as being on top of the finger piece 304, in other embodiments, the tactile sensing element 302 may be at other suitable locations. For example, FIG. 3B is a schematic cross-sectional diagram illustrating another input element 300′ suitable for use in a first input device 106 such as physical keyboard shown in FIGS. 1 and 2, arranged in accordance with embodiments of the present disclosure. As shown in FIG. 3B, the tactile sensing element 302 may be positioned adjacent the shaft 308 and spaced apart from the finger piece 304. In further examples, the tactile sensing element 302 may be positioned in other suitable locations or be omitted.

FIG. 3C is a schematic plan view diagram illustrating another example physical keyboard that may be suitable for use as first input device 106 in electronic device 100 shown in FIGS. 1 and 2, arranged in accordance with at least some embodiments of the present disclosure. As shown in FIG. 3C, the first input device 106 may include a plurality of input elements 318, and a number of infrared sensing elements 311 individually having a pairs of transmitters 310, 314 and respective receivers 312, 316 arranged around the input elements 318. The transmitters 310, 314 can be configured to emit infrared beams 313 and the receivers 312, 316 can be configured to detect the emitted infrared beams 313 (only a few are shown for clarity). The infrared sensing elements 311 can detect finger locations of a user by monitoring the infrared beams blocked by the user's fingers (not shown). The infrared sensing elements may generate a sense signal indicative of the finger location of the user. When the user presses an input element with the help of indication of finger location on the display, the input element in the first input device 106 may detect an actuation from the user on the input element and generate an input signal based on the detected actuation.

Although in the above examples, the sensor is separated from input elements of the first input device 106, in other examples, the sensor can be integrated with the keys of the first input device 106. FIG. 3D is a schematic plan view diagram illustrating a further example first input device suitable for the handheld electronic device shown in FIGS. 1 and 2, arranged in accordance with at least some embodiments of the present disclosure. FIG. 3E is a schematic cross-sectional diagram of the first input device shown in FIG. 3D. As shown in FIG. 3D, the first input device 106″ may include a plurality of input elements 321 and each of input elements 321 may include a touch sensor (only a few are shown for clarity). As shown in FIG. 3E, each of the input elements 321 may have a convex shape. In other embodiments, each of input elements 321 may have other suitable shape such as concave shape so that the user may get a force feedback when touching the input elements 321 by user's finger 301.

FIG. 4 is a schematic diagram illustrating an example circuit that may be suitable for use with the handheld electronic device 100 shown in FIGS. 1 and 2, arranged in accordance with at least some embodiments of the present disclosure. As shown in FIG. 4, the handheld electronic device 100 can include a display 102, a display controller 404, a processor 406 (e.g., a logic processor), a storage device 408 (e.g., a solid state storage device), a port 410 (e.g., a USB port), and a first input device 106 coupled together for operation. In the illustrated embodiment, the first input device 106 may include input elements 416, an input circuit 412, sensors 418 and a sensor circuit 414. The sensor circuit 414 may be configured to receive a sense signal indicative of finger locations of a user from, for example, a tactile sensing element such as the tactile sensing element 302 illustrated in FIGS. 3A and 3B. The input circuit 412 may be configured to receive an input signal indicative of actuation from a user from, for example, the input elements 300 illustrated in FIGS. 3A and 3B. In other embodiments, one or more of the input circuit 412 or the sensor circuit 414 may be implemented as a separate device from the first input device 106. In still other embodiments the functions of the input circuit 412 and the sensor circuit 414 may be integrated together into a single device. In the illustrated embodiment, the handheld electronic device 100 can include a second input device 107 for input by a user from the first side (e.g., the front side) of the handheld electronic device. In operation, a user may use the first input device 106 and/or the second input device 107 to input data to the handheld electronic device 100 at faster rates than conventional devices.

The storage device 408 may be configured to store instructions for operating the handheld electronic device 100. For example, the processor 406 can be configured to execute instructions that are stored in the storage device 408. The execution of some of the instructions by processor 406 may be effective to initiate a control signal to the display controller 404 to generate indications of finger locations on the display 102 based on received sense signals from the sensor circuit 414. The processor 406 can also be configured to execute instructions effective to evaluate one or more received input signals indicative of actuation (e.g., user input selection) from the input circuit 412 and to identify corresponding symbols such as letters, numbers, or other keystrokes or movements. Certain example operations of the handheld electronic device 100 are described in more detail below with reference to FIGS. 5-13.

FIG. 5 is a flow diagram illustrating an example process 500 that may be suitable for operating the handheld electronic device 100 of FIGS. 1 and 2, arranged in accordance with at least some embodiments of the present disclosure. Corresponding example visual outputs are illustrated in FIGS. 6-13. The example process 500 may include various operations, functions, or actions as illustrated by one or more blocks 502-510.

The process 500 may begin at block 502, “Enable an Application to Input Text,” where an application (e.g., an SMS application) may facilitate user input such as text from a first input device 106. As shown in FIG. 6, a text box 602 and the “virtual” keyboard (e.g., second input device 107) corresponding to the first input device 106 (FIG. 2) located at the second side 100b (FIG. 2) and presented on the display 102 so that the user can visualize the location of the backside user input device (e.g., first input device 106). In certain embodiments, the second input device 107 may have input elements substantially corresponding to respective input elements in the first input device 106. In other embodiments, the second input device 107 may include different input elements than those in the first input device 106. In other examples, the first input device 106 may not be a keyboard at all, but some other user input device such as a keypad, joystick, joypad, touchpad, mouse, scroll wheel, pointer or some other input device.

Block 502 may be followed by block 504, “Sense a Finger Location of a User Relative to an Input Element and Generate a Sense Signal.” In some examples, at block 504, the process 500 may include detecting finger locations of the user relative to an input element of the first input device 106 and generating corresponding sense signals. In some embodiments, the finger locations may be detected using tactile sensing elements such as those described with reference to FIGS. 3A and 3B. In other embodiments, the finger locations may be detected using infrared sensors such as those described with reference to FIGS. 3C, 3D and 3E. In further embodiments, the finger locations may be detected using other suitable techniques such as touchpads, touch panels, buttons, keys or any other suitable type of detected user input mechanism.

Block 504 may be followed by block 506, “Provide an Indication of the Finger Location on the Display Based on the Sense Signal.” In some examples, at block 506, the process 500 may include presenting one or more indications on the display 102 to indicate the detected finger locations of the user. For example, as shown in FIG. 7, when the eight fingers of the user touches keys “E,” “D,” “X,” “?123,” “O,” “K,” “@,” and “?123,” respectively, the corresponding keys 702, 704, 706 and 708 on the “virtual” keyboard on the display 102 may be highlighted in a semi-transparent or other suitable manner. As a result, the user may identify that the four fingers on the left hand correspond to keys “E,” “D,” “X,” and “?123.,” while the four fingers on the right hand correspond to the keys shown on the virtual keys “O,” “K,” “@,” and “?123.”

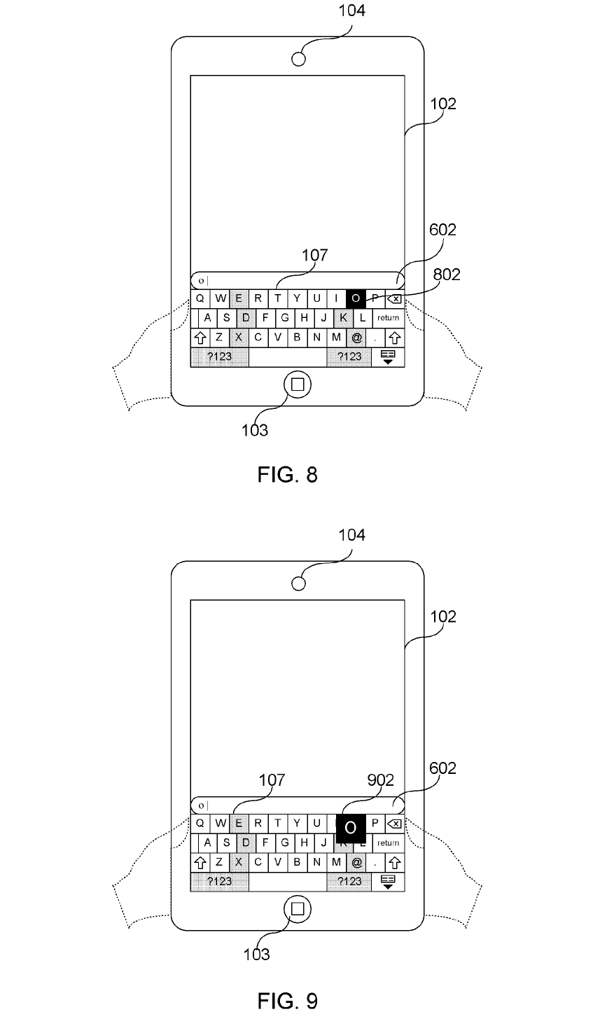

Block 506 may be followed by block 508, “Detect User Input Selection.” In some examples, at block 508, the process 500 may include detecting a keystroke from the user when the user actuates an input element corresponding to the detected location/function identified at block 506. In some examples, as shown in FIG. 8, as the user presses the key “O,” the corresponding key on the “virtual” keyboard (e.g., second input device 107) can be highlighted to indicate the keystroke. In the illustrated embodiment, the depressed key “O” 802 can be highlighted with a more opaque color. In other embodiments, the depressed key may also be displayed as an enlarged and/or highlighted key 902, as shown in FIG. 9 and/or in other suitable fashion.

Block 508 may be followed by block 510, “Perform an Action Associated with the Detected Input Selection.” In some examples, at block 510, the process 500 may include performing an action in association with the detected input selection, for example, converting the detected keystroke into a visual symbol or enabling an action based on the movement of the finger on the input elements of first input device 106. In the example shown in FIGS. 8 and 9, a letter “o” may be entered in the text box 602. In other embodiments, the process 500 can include enabling an action corresponding to one (e.g., depressing the “return” key, or “ctrl” key, etc.) of the keys of the keyboard associated with the detected keystroke. In still other embodiments, the process 500 can include enabling an action corresponding to movement of a pointing device such as a mouse, cursor, or perhaps a gamepiece in a video game, or other visual object on the display.

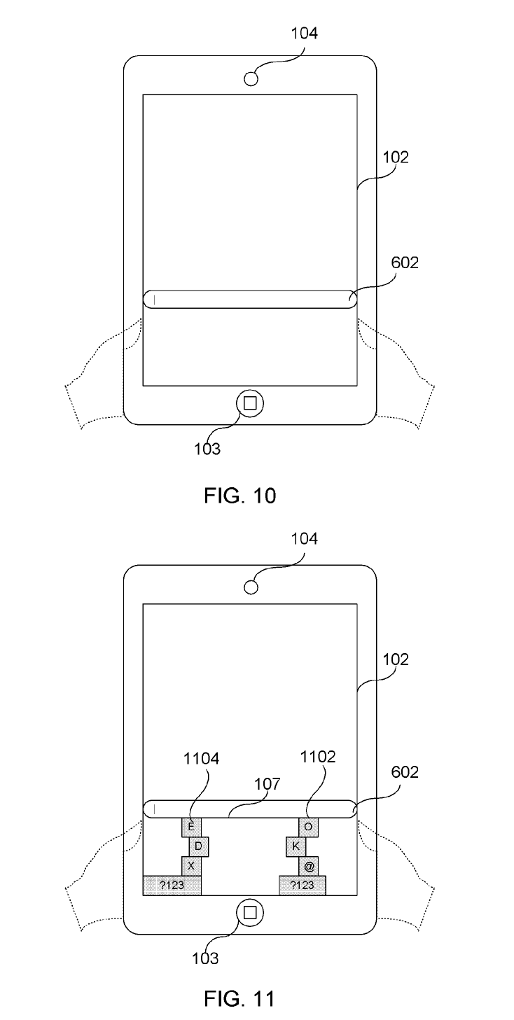

In certain embodiments, the “virtual” keyboard may be partially presented on the display 102. For example, various keys on the “virtual” keyboard corresponding to the touched input elements on the first input device 106 may be presented so that the user may quickly identify a location of one or more of the user's fingers at the backside. For instance, as shown in FIG. 10, after an SMS application is enabled, the text box 602 may be presented on the display 102. When finger locations of the user are detected, the corresponding keys on the “virtual” keyboard may be presented on the display 102 while at least a portion of the other keys may not be presented. For example, as shown in FIG. 11, the indications 1104 and 1102 and corresponding keys “E,” “D,” “X,” “?123,” “O,” “K,” “@” and “?123” on the “virtual” keyboard are presented on the display 102.

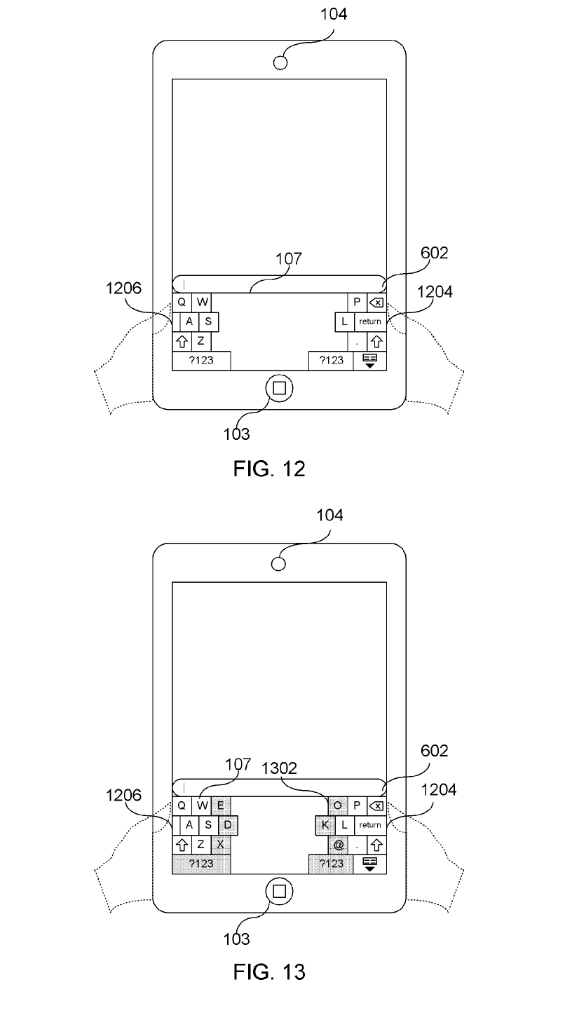

In further embodiments, both the second input device 107 and the first input device 106 may be simultaneously used to enter data. As shown in FIG. 12, after an SMS application is enabled, the virtual keys 1206 at the left side and the virtual keys 1204 at the right side of the “virtual” keyboard (e.g., second input device 107) can be presented on the display 102 for inputting by thumbs. In the illustrated embodiment, the “virtual” keyboard may only be partially presented on the display 102 for accepting user input. In other embodiments, additional keys on the “virtual” keyboard may be presented on the display 102. In further embodiments, the entire “virtual” keyboard may be presented on the display 102. As shown in FIG. 13, when finger locations of the user relative to an input element of the user input device 106 are detected, one or more indications 1302 may be provided on the display 102 to indicate the finger locations of the user.

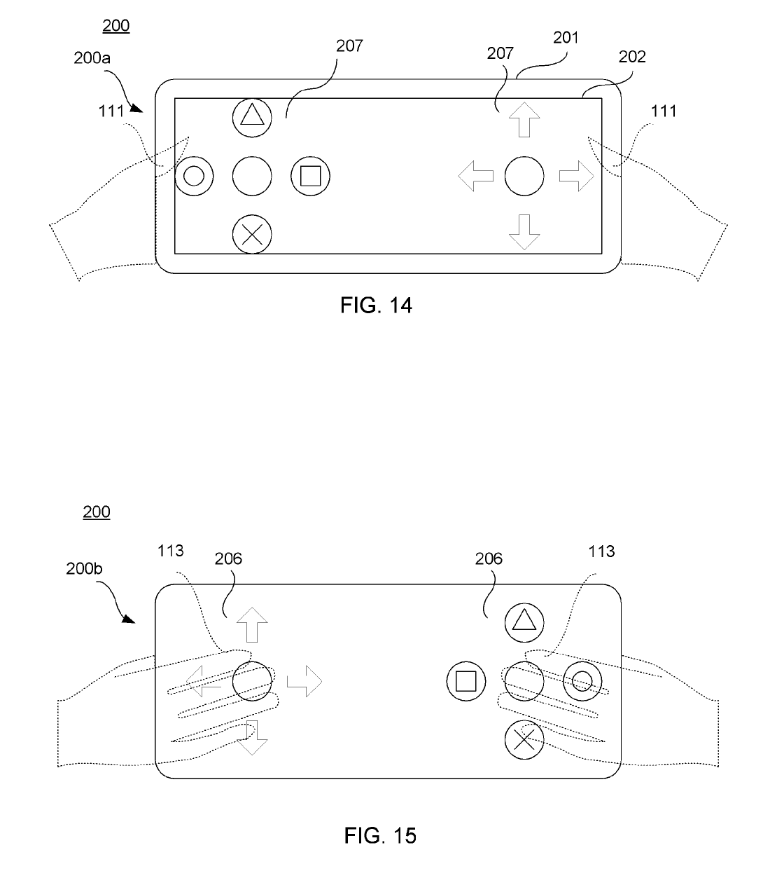

FIG. 14 is a schematic diagram illustrating a front view and FIG. 15 is a schematic diagram illustrating a back view of a handheld electronic device 200, arranged in accordance with at least some embodiments of the present disclosure. The handheld electronic device 200 can be a game controller, a smart phone, a person digital assistant (PDA), and/or other suitable handheld electronic devices. Referring to both FIGS. 14 and 15, the handheld electronic device 200 can include a housing 201 having a first side 200a opposite a second side 200b. In some examples, the first and second sides 200a, 200b correspond to front and back sides of the handheld electronic device 200, respectively. The handheld electronic device 200 can also include a display 202 on the first side 200a and a first input device 206 on the second side 200b of the housing 201. The handheld electronic device 200 can also include one or more of a processor, a display controller, a storage device, and/or other electrical components internally located in the housing 201. The handheld electronic device 200 can have generally similar configuration as the handheld device 100, as described in more detailed above with reference to FIG. 4. As a result, the configurations of the handheld electronic device 200 are omitted for clarity.

In various embodiments, the handheld electronic device 200 may have a second input device 207 at the first side 200a. The second input device 207 can have a plurality of input elements such as keys, buttons, switches, user-defined key positions or other suitable input elements configured to be actuated by a user. In the illustrated embodiment, the handheld electronic device 200 may present a “virtual” joypad on the display 202. The “virtual” joypad may be a software joypad generally corresponding to the first input device 206. The “virtual” joypad can be configured to output indications of finger locations on the second side 200b of the housing 201 and/or to accept user actuation, as described in more detail below with reference to FIGS. 17-20.

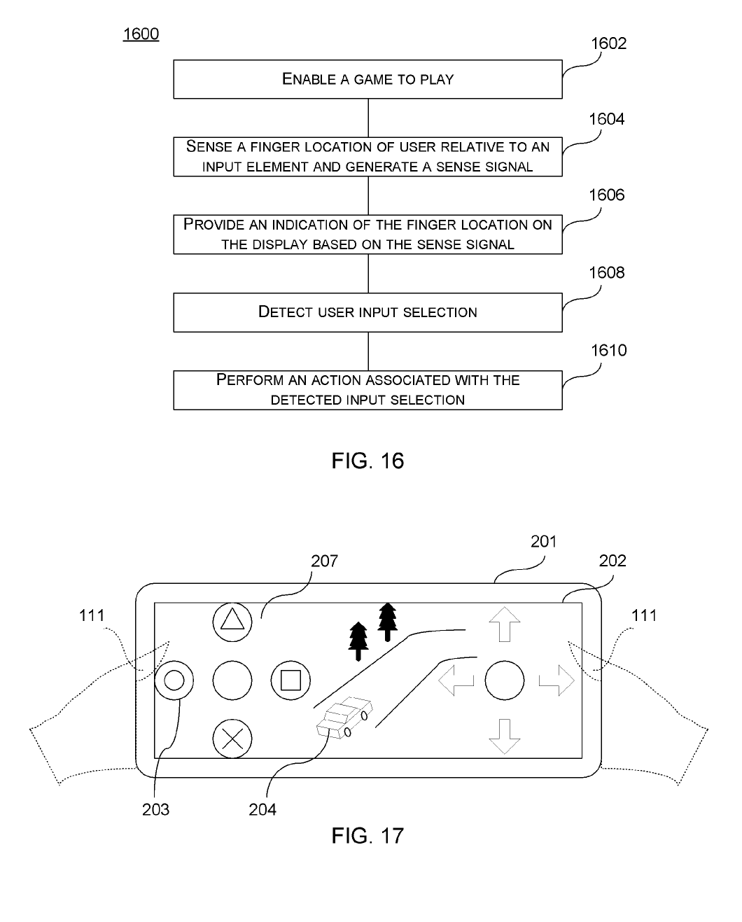

FIG. 16 is a flow diagram illustrating an example process 1600 that may be suitable for operating the handheld electronic device 200 of FIGS. 14 and 15, arranged in accordance with at least some embodiments of the present disclosure. Corresponding example visual outputs are illustrated in FIGS. 17-20. The example process 1600 may include various operations, functions, or actions as illustrated by one or more blocks 1602-1610.

The process 1600 may begin at block 1602, “Enable a Game to Play,” where a game may be a race game to be played by using first input device 206. As shown in FIG. 17, a race game scene including a car 204 and the “virtual” joypad (e.g., second input device 207) corresponding to the first input device 206 (FIG. 14) located at the second side 200b (FIG. 15) may be presented on the display 102 so that the user can visualize the location of the backside user input device (e.g., first input device 206). In certain embodiments, the second input device 207 may have input elements substantially corresponding to respective input elements in the first input device 206. In other embodiments, the second input device 207 may include different input elements than those in the first input device 206.

Block 1602 may be followed by block 1604, “Sense a Finger Location of a User Relative to an Input Element and Generate a Sense Signal.” In some examples, at block 1604, the process 1600 may include detecting finger locations of the user relative to an input element of the first input device 206 and generating corresponding sense signals. In some embodiments, the finger locations may be detected using tactile sensing elements such as those described with reference to FIGS. 3A and 3B. In other embodiments, the finger locations may be detected using infrared sensors such as those described with reference to FIGS. 3C, 3D, and 3E. In further embodiments, the finger locations may be detected using other suitable techniques such as touchpads, touch panels, buttons, keys or any other suitable type of detected user input mechanism.

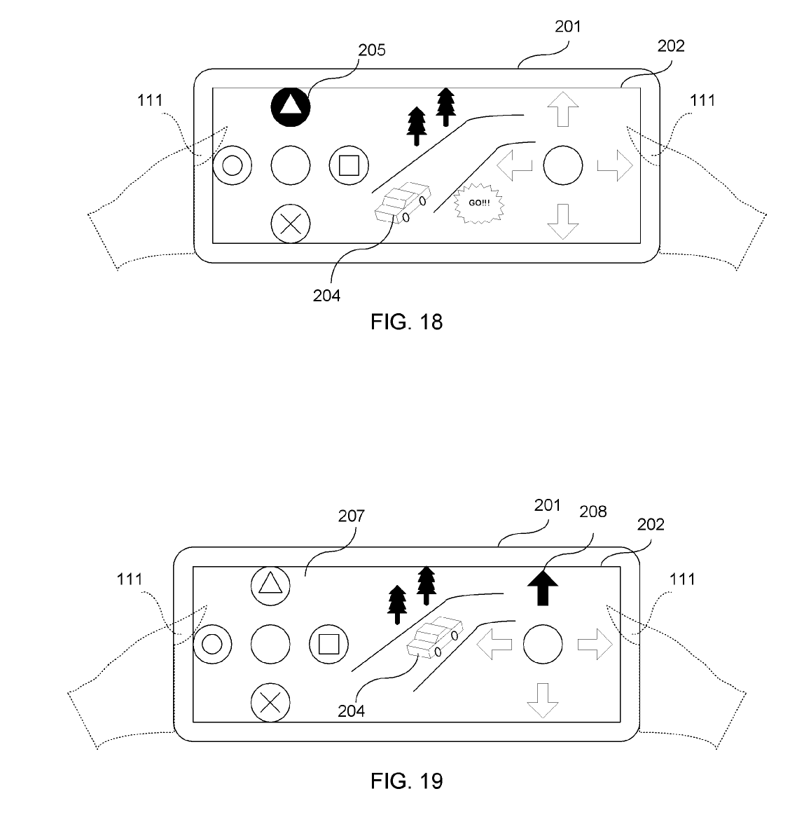

Block 1604 may be followed by block 1606, “Provide an Indication of the Finger Location on the Display Based on the Sense Signal.” In some examples, at block 1606, the process 1600 may include presenting one or more indications on the display 202 to indicate the detected finger locations of the user. For example, as shown in FIG. 18, when a finger of the user touches an input element, the corresponding input element 205 on the “virtual” joypad on the display 202 may be highlighted or other suitable manner. As a result, the user may identify that the finger on the left hand correspond to input element 205.

Block 1606 may be followed by block 1608, “Detect User Input Selection.” In some examples, at block 1608, the process 1600 may include detecting actuation from the user when the user actuates an input element corresponding to the detected location/function identified at block 1606. In the illustrated embodiment, the depressed key corresponding to virtual key 205 can be highlighted with a more opaque color. In other embodiments, the depressed key may also be displayed as an enlarged and/or highlighted key and/or in other suitable fashions.

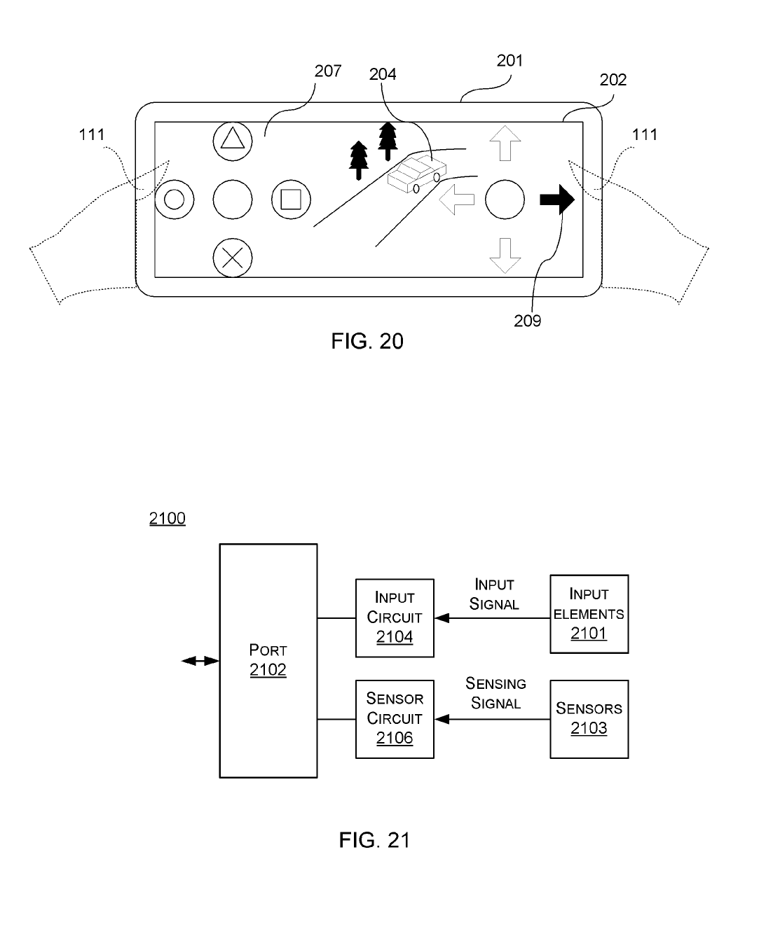

Block 1608 may be followed by block 1610, “Perform an Action Associated with the Detected Input Selection.” In some examples, at block 1610, the process 1600 may include controlling an object in the game. In the example shown in FIG. 18, the car 204 starts to run when the key corresponding to the virtual key 205 is depressed. In other embodiments, the process 1600 can include enabling an action corresponding to one (e.g., depressing the “up” key, “down,” “right,” or “left” key, etc.) of the keys of the joypad associated with the detected actuation. In still other embodiments, the process 1600 can include enabling an action corresponding to depressing of the key associated with the virtual key “up” 208, as shown in FIG. 19, and/or depressing of the key associated with the virtual key “right” 209, as shown in FIG. 20.

Even though the handheld electronic devices 100, 200 are described above as having the first input device 106, 206 as an integral component, in certain embodiments, the first input devices 106, 206 can be implemented as an attachment to a cellular phone, a tablet computer, a laptop computer, a personal data assistant, or other suitable electronic devices, as illustrated in FIG. 21. As shown in FIG. 21, a first input device 2100 may include a plurality of input elements 2101, sensors 2103, an input circuit 2104, a sensor circuit 2106, and a port 2102. In certain embodiments, the sensors 2103 can be configured to detect finger locations of a user relative to one of the input elements 2101, and generate corresponding sense signals. The sensor circuit 2106 can be configured to receive the sense signals indicative of the finger locations and transmit the received signals, e.g., such as signals in digital form to a processor (not shown) via the port 2102. The input circuit 2104 can be configured to receive input signals indicative of user input functions and transmit the received signals, e.g., such as signals in digital form, to a processor via the port 2102.

In additional examples, the handheld electronic device 100 of FIG. 1 can include a virtual keyboard that can be user reconfigured to operate similar to a handheld electronic device 200 of FIGS. 14 and 15. In one example, a tablet computer type of device can include a mechanical or virtual input user device on a backside that can be utilized as a game controller type of input device, where the virtual keyboard that is visible on the front side of the device may be reconfigured to illustrate the user actuated inputs on the game controller during operation. In another example, a tablet computer type of device can include a mechanical or virtual input user device on a backside that can be utilized as a pointer or mouse and button type of input device, where the virtual keyboard that is visible on the front side of the device may be reconfigured to illustrate the user actuated inputs on the pointer or mouse and button type of input device. Additional examples are also contemplated where the front side and back side user devices may be either the same as one another or different from one another depending on the desired use.

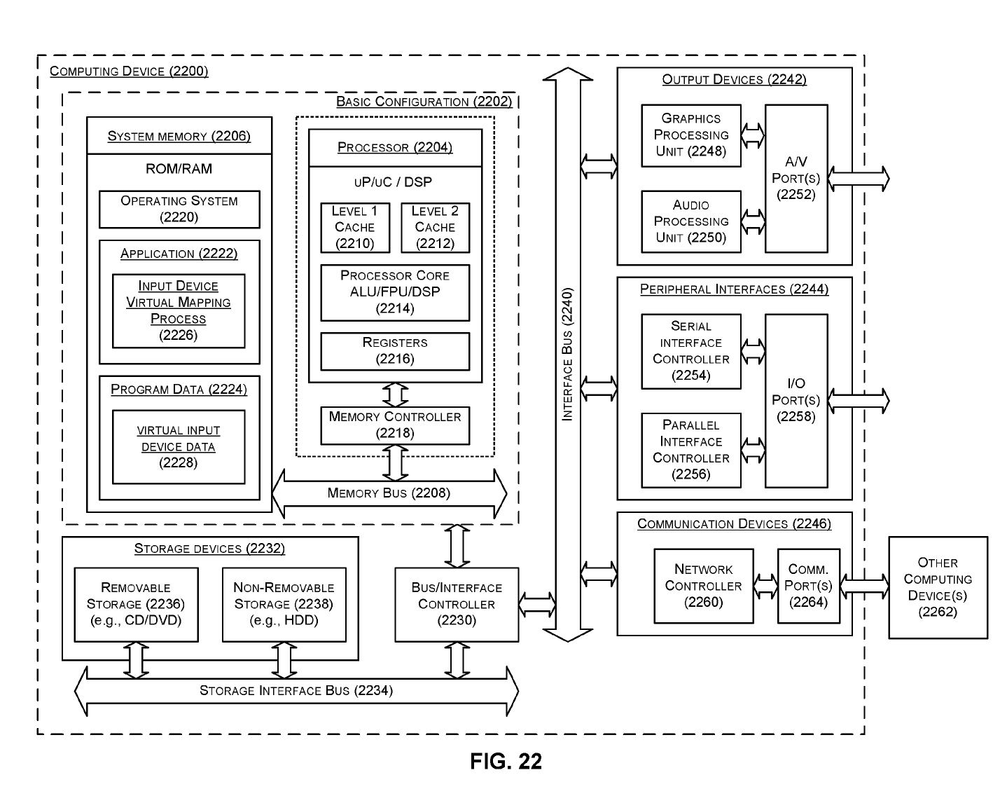

FIG. 22 is a schematic diagram illustrating an example computing device that may be configured for use as a portion of the handheld electronic devices in accordance with the present disclosure. In a very basic configuration 2202, computing device 2200 typically includes one or more processors 2204 and a system memory 2206. A memory bus 2208 may be used for communicating between processor 2204 and system memory 2206.

Depending on the desired configuration, processor 2204 may be of any type including but not limited to a microprocessor (μP), a microcontroller (μC), a digital signal processor (DSP), or any combination thereof. Processor 2204 may include one more levels of caching, such as a level one cache 2210 and a level two cache 2212, a processor core 2214, and registers 2216. An example processor core 2214 may include an arithmetic logic unit (ALU), a floating point unit (FPU), a digital signal processing core (DSP Core), or any combination thereof. An example memory controller 2218 may also be used with processor 2204, or in some implementations memory controller 2218 may be an internal part of processor 2204.

Depending on the desired configuration, system memory 2206 may be of any type including but not limited to volatile memory (such as RAM), non-volatile memory (such as ROM, flash memory, etc.) or any combination thereof. System memory 2206 may include an operating system 2220, one or more applications 2222, and program data 2224. Application 2222 may include an Input Device Virtual Mapping Process 2226 that is arranged to receive a sense signal indicative of finger location of a user relative to one of a plurality of input elements of the first input device and present an indication on a display screen. Program data 2224 may include virtual input device data 2228 that may be useful for the process of operating handheld electronic devices as is described herein. In some embodiments, application 2222 may be arranged to operate with program data 2224 on operating system 2220 such that the user may understand the location of fingers even if the fingers are blocked by the handheld electronic device. This described basic configuration 2202 is illustrated in FIG. 22 by those components within the inner dashed line.

Computing device 2200 may have additional features or functionality, and additional interfaces to facilitate communications between basic configuration 2202 and any required devices and interfaces. For example, a bus/interface controller 2230 may be used to facilitate communications between basic configuration 2202 and one or more data storage devices 2232 via a storage interface bus 2234. Data storage devices 2232 may be removable storage devices 2236, non-removable storage devices 2238, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 2206, removable storage devices 2236 and non-removable storage devices 2238 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 2200. Any such computer storage media may be part of computing device 2200.

Computing device 2200 may also include an interface bus 2240 for facilitating communication from various interface devices (e.g., output devices 2242, peripheral interfaces 2244, and communication devices 2246) to basic configuration 2202 via bus/interface controller 2230. Example output devices 2242 include a graphics processing unit 2248 and an audio processing unit 2250, which may be configured to communicate to various external devices such as a display or speakers via one or more A/V ports 2252. Example peripheral interfaces 2244 include a serial interface controller 2254 or a parallel interface controller 2256, which may be configured to communicate with external devices such as input devices (e.g., keyboard, mouse, pen, voice input device, touch input device, etc.) or other peripheral devices (e.g., printer, scanner, etc.) via one or more I/O ports 2258. An example communication device 2246 includes a network controller 2260, which may be arranged to facilitate communications with one or more other computing devices 2262 over a network communication link via one or more communication ports 2264.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 2200 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 2200 may also be implemented as a personal computer including both laptop computer and non-laptop computer configurations.

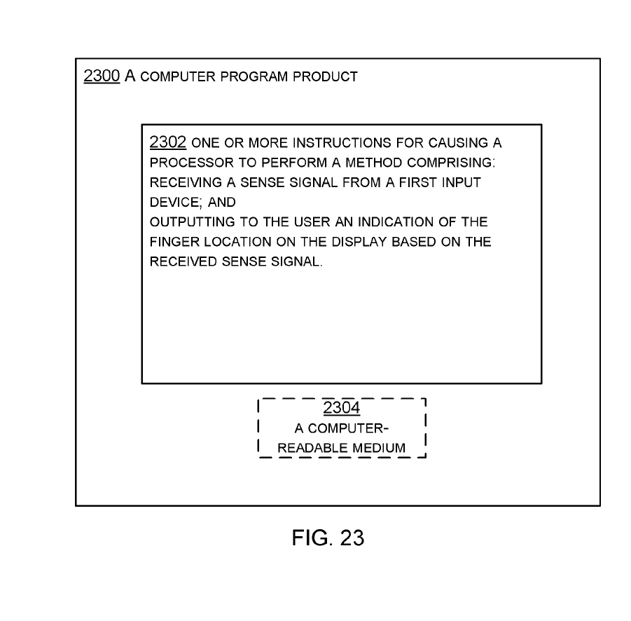

FIG. 23 is a schematic diagram illustrating an example computer program product 1600 that may include a computer program for executing a computer process on a computing device to perform Input Device Virtual Mapping Process. The computer program product 2300 may be a computer readable medium 2304 storing one or more instructions 2302. When executed by the processor, the instructions cause the processor to perform a method comprising: receiving the sense signal from the first input device; and outputting to the user an indication of the finger location on the display based on the received sense signal.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A handheld electronic device, comprising:
a housing that includes a first side and a second side;
a display at the first side of the housing;
a first input device at the second side of the housing, wherein the first input device includes a plurality of input elements and a sensor, the plurality of input elements are configured to be actuated, the sensor is configured to detect a finger location relative to one of the plurality of input elements and generate a sense signal, at least a portion of the first input device that is associated with the finger location is not visible from the first side of the housing, and the sense signal represents the detected finger location; and
a controller in the housing and operatively coupled to the first input device and display, wherein the controller is configured to receive the sense signal from the sensor and to generate an indication of the finger location on the display based on the received sense signal such that the finger location relative to the one of the plurality of input elements of the first input device is identifiable despite the finger location being not visible from the first side of the housing.

2. (canceled)

3. The handheld electronic device of claim 1, wherein:
the first input device is also configured to detect actuation on the one of the plurality of input elements and generate an input signal based on the detected actuation; and
the controller is further configured to receive the input signal from the first input device, and in response to the input signal, present on the display a visual symbol that corresponds to the one of the plurality of input elements of the first input device associated with the detected actuation and/or enable an action that corresponds to the one of the plurality of input elements of the first input device associated with the detected actuation.

4. The handheld electronic device of claim 1, wherein the indication is provided at a first position on the display at the first side of the housing, the first position generally overlaps with a second position of the one of the plurality of input elements on the first input device and the second position is associated with the detected finger location.

5. The handheld electronic device of claim 1, further comprising:
a second input device that includes a virtual input device output from the controller on the display at the first side of the housing, wherein the virtual input device generally corresponds to at least a portion of the first input device at the second side of the housing; and
the indication is provided at a first position on the virtual input device, wherein the first position generally overlaps with a second position of the one of the plurality of input elements on the first input device and the second position is associated with the detected finger location.

6-7. (canceled)

8. The handheld electronic device of claim 1, further comprising:
a second input device at the first side of the housing and operatively coupled to the controller, wherein the second input device includes a plurality of input elements configured to be actuated;
the second input device is configured to detect actuation on one of the plurality of input elements of the second input device and generate an input signal based on the detected actuation; and
the controller is further configured to receive the input signal from the second input device, and in response to the input signal, present on the display a visual symbol that corresponds to the one of the plurality of input elements of the second input device associated with the detected actuation and/or enable an action that corresponds to the one of the plurality of input elements of the second input device associated with the detected actuation.

9. The handheld electronic device of claim 1, wherein:
the sensor comprises a plurality of tactile sensor elements individually arranged on the plurality of input elements; and
the tactile sensor elements are individually configured to detect the finger location by sense of a touch of a finger.

10. (canceled)

11. The handheld electronic device of claim 1, wherein:
the sensor comprises a plurality of infrared sensor elements that individually include a transmitter and a receiver arranged around the plurality of input elements, wherein the transmitter is configured to emit an infrared beam and the receiver is configured to detect the emitted infrared beam; and
the infrared sensor elements are configured to detect the finger location by monitor of the infrared beams blocked by a finger.

12. The handheld electronic device of claim 1, wherein:
the sensor comprises a touch panel;
each of the plurality of input elements comprises a tactile region on the touch panel, wherein the tactile region includes a convex shape or a concave shape; and
the touch panel is configured to detect the finger location by sense of a touch of a finger on the tactile region.

13. The handheld electronic device of claim 1, wherein:
the display comprises a touch screen;
the handheld electronic device further comprises a second input device that includes a virtual input device output from the controller on the display at the first side of the housing, wherein the virtual input device includes a plurality of virtual input elements and is configured to generate an input signal based on a touch on the touch screen; and
the controller is further configured to receive the input signal from the virtual input device, and in response to the input signal, present on the display a visual symbol that corresponds to a touched virtual input element of the virtual input device and/or enable an action that corresponds to the touched virtual input element of the virtual input device.

14. The handheld electronic device of claim 1, wherein the handheld electronic device comprises a tablet computer, a cellular phone, a laptop computer, or a personal data assistant.

15. An input device, comprising:
a plurality of input elements individually configured to generate an input signal in response to actuation;
a sensor associated with the plurality of input elements, wherein the sensor is configured to detect a finger location relative to one of the plurality of input elements and generate a sense signal, at least a portion of the input device that is associated with the finger location is not visible from a viewable side of a display, and the sense signal represents the detected finger location; and
a port configured to transmit the input signal and the sense signal to a processor to output an indication of the finger location on the display based on the sense signal such that the finger location relative to the one of the plurality of input elements of the input device is identifiable despite the finger location being not visible from the viewable side of the display.

16. The input device of claim 15, wherein:
the sensor comprises a plurality of tactile sensor elements respectively associated with an individual one of the plurality of input elements; and
the tactile sensor elements are individually configured to detect the finger location by sense of a touch of a finger.

17. (canceled)

18. The input device of claim 15, wherein:
the sensor comprises a plurality of infrared sensor elements that individually include a transmitter and a receiver arranged around the plurality of input elements, wherein the transmitter is configured to emit an infrared beam and the receiver is configured to detect the emitted infrared beam; and
the infrared sensor elements are configured to detect the finger location by monitor of the infrared beams blocked by a finger.

19. The user input device of claim 15, wherein each of the plurality of input elements includes:
a finger piece;
a shaft spaced apart from the finger piece;
a spring attached to the finger piece and the shaft, wherein the spring biases the finger piece away from the shaft; and
an electrical terminal spaced apart from the shaft, wherein the electrical terminal is configured to close an electrical circuit in response to contact by the shaft with the electrical terminal.

20-21. (canceled)

22. The input device of claim 15, wherein:
the sensor comprises a touch panel;
each of the plurality of input elements comprises a tactile region on the touch panel, wherein the tactile region includes a convex shape or a concave shape; and
the touch panel is configured to detect the finger location by sense of a touch of a finger on the tactile region.

23. A method to operate a handheld electronic device, the method comprising:
detecting a finger location relative to one of a plurality of input elements of a first input device, wherein at least a portion of the first input device that is associated with the finger location is not visible from a viewable side of a display of the handheld electronic device;
generating a sense signal that represents the detected finger location;
transmitting the sense signal to a processor; and
with the processor, outputting an indication of the finger location on the display based on the sense signal such that the finger location relative to the one of the plurality of input elements of the first input device is identifiable despite the finger location being not visible from the viewable side of the display.

24. The method of claim 23, further comprising:
detecting actuation of the one of the plurality of input elements of the first input device and generating an input signal based on the detected actuation, wherein the detected actuation is associated with a detected input;
transmitting the input signal to the processor; and
with the processor, outputting a visual symbol on the display that identifies the detected input.

25. The method of claim 23, further comprising:
detecting actuation of the one of the plurality of input elements of the first input device and generating an input signal based on the detected actuation, wherein the detected actuation is associated with a detected input;
transmitting the input signal to the processor; and
with the processor, enabling an action that corresponds to the detected input.

26. The method of claim 23, further comprising:
detecting actuation of the one of the plurality of input elements of the first input device and generating an input signal based on the detected actuation, wherein the detected actuation is associated with a detected input;
transmitting the input signal to the processor; and
with the processor, outputting a new indication that corresponds to the input on the display.

27. The method of claim 23, further comprising:
detecting actuation of one of a plurality of input elements of a second input device and generating an input signal based on the detected actuation, wherein the detected actuation is associated with a detected input;
transmitting the input signal to the processor; and
with the processor, outputting a visual symbol on the display that identifies the detected input.

28. The method of claim 23, further comprising:
detecting actuation of one of a plurality of input elements of a second input device and generating an input signal based on the detected actuation, wherein the detected actuation is associated with a detected input;
transmitting the input signal to the processor; and
with the processor, enabling an action that corresponds to the detected input.

29. The method of claim 23, further comprising:
outputting a virtual input device on the display, wherein the first input device includes at least one input element that is occluded from view;
detecting actuation of the at least one input element and generating an input signal based on the detected actuation;
transmitting the input signal to the processor; and
with the processor, highlighting a virtual input element of the virtual input device, wherein the virtual input element corresponds to the at least one input element of the first input device associated with the detected actuation.

30. The method of claim 23, further comprising:
outputting a virtual input device on the display, wherein the first input device includes at least one input element that is occluded from view, and the virtual input device generally overlaps with the first input device;
wherein outputting includes outputting an indication of the finger location on the display, the indication being at a position on the display that generally overlaps a position of the at least one input element on the first input device.

31. (canceled)

32. A non-transitory computer-readable medium having stored thereon computer-readable instructions, which in response to execution by a processor, cause the processor to perform or control performance of the method of claim 23.

33-41. (canceled)
